(19) United States
(12) Patent Application Publication
(10) Pub. No.: US 2025/0112583 A1
(43) Pub. Date: Apr. 3, 2025

(54) Photovoltaic Shade Structures and Related Methods and Assemblies

(71) Applicant: Genesis Pergolas LLC, Eagle Mountain, UT (US)

(72) Inventors: Beau Gunderson, South Jordan, UT (US); Drew Gunderson, Eagle Mountain, UT (US)

(73) Assignee: Genesis Pergolas LLC, Eagle Mountain, UT (US)

(21) Appl. No.: 18/897,815

(22) Filed: Sep. 26, 2024

Related U.S. Application Data
(60) Provisional application No. 63/587,109, filed on Sep. 30, 2023.

(51) Int. Cl. H02S 20/10; E04D 13/064

(52) U.S. Cl. CPC H02S 20/10; E04D 13/064

(57) ABSTRACT

A photovoltaic shade structure may include a plurality of posts, a plurality of beams at least partially structurally supported by the posts, and a plurality of joists at least partially structurally supported by the beams. A plurality of solar panels may be at least partially structurally supported by the joists. Each of the joists may have a longest length that is substantially perpendicular with a longest length of each of the solar panels.

### CROSS REFERENCE TO RELATED APPLICATIONS

This document claims the benefit of the filing date of U.S. Provisional Patent Application No. 63/587,109, entitled “Photovoltaic Shade Structures and Related Methods and Assemblies,” naming as first inventor Beau Gunderson, which was filed on Sep. 30, 2023, the disclosure of which is hereby incorporated entirely herein by reference.

### BACKGROUND

### 1. Technical Field

Aspects of this document relate generally to shade structures. Particular aspects relate to shade structures configured to hold or couple with photovoltaic apparatuses, such as solar cells or solar panels.

### 2. Background Art

Solar panels and solar cells are sometimes used on the roofs of structures, such as houses or other buildings, to provide energy capture. Shade structures such as pergolas exist in the art and are sometimes used to provide shade and/or to otherwise provide covering, such as from rain or other inclement weather. Shade structures are accordingly generally placed in an outdoor location, such as on a patio, on a porch, or in a yard or other grassy or other ground area. Some solar panels have been coupled with pergolas in the past so as to utilize the top area of the pergola for energy capture.

### SUMMARY

In some aspects, the techniques described herein relate to a photovoltaic shade structure, including: a plurality of posts; a plurality of beams at least partially structurally supported by the posts; a plurality of joists at least partially structurally supported by the beams; and a plurality of solar panels at least partially structurally supported by the joists; wherein each of the joists includes a longest length that is substantially perpendicular with a longest length of each of the solar panels.

In some aspects, the techniques described herein relate to a photovoltaic shade structure, wherein each of the joists is formed of multiple members.

In some aspects, the techniques described herein relate to a photovoltaic shade structure, further including a gutter secured between two of the multiple members of one of the joists, the gutter configured to route rainwater to an outer edge of the photovoltaic shade structure.

In some aspects, the techniques described herein relate to a photovoltaic shade structure, wherein the gutter is centrally located between two rows of the solar panels, and wherein the gutter extends from a first outer edge of the photovoltaic shade structure to a second outer edge of the photovoltaic shade structure.

In some aspects, the techniques described herein relate to a photovoltaic shade structure, further including a cable rest secured between two of the multiple members of one of the joists, the cable rest configured for routing electrical wiring from the solar panels to an electrical load or to power storage.

In some aspects, the techniques described herein relate to a photovoltaic shade structure, further including a gutter configured to route rainwater to an outer edge of the photovoltaic shade structure.

In some aspects, the techniques described herein relate to a photovoltaic shade structure, wherein each of the beams is formed of multiple members.

In some aspects, the techniques described herein relate to a photovoltaic shade structure, wherein at least one of the beams includes a gap formed between two of its multiple members, the gap configured for routing electrical wiring from the solar panels to an electrical load or to power storage.

In some aspects, the techniques described herein relate to a photovoltaic shade structure, further including a clamp configured for selectively securing one of the solar panels to one of the joists.

In some aspects, the techniques described herein relate to a photovoltaic shade structure, further including a bracket configured to couple the clamp with the solar panel, the bracket configured to provide a downward force on the solar panel in response to a movement of the clamp.

In some aspects, the techniques described herein relate to a photovoltaic shade structure, wherein the clamp is configured to secure two adjacent solar panels to the joist.

In some aspects, the techniques described herein relate to a photovoltaic shade structure, wherein the clamp includes a locking mechanism which, when in a locked configuration, prevents the secured solar panel from being decoupled from the joist.

In some aspects, the techniques described herein relate to a photovoltaic shade structure, further including a beam wrap substantially covering one of the posts.

In some aspects, the techniques described herein relate to a photovoltaic shade structure, further including a sealant joining adjacent surfaces of two of the solar panels, the sealant preventing water from passing therethrough.

In some aspects, the techniques described herein relate to a photovoltaic shade structure, further including a clamp configured to push two of the solar panels toward one another and to secure the two solar panels to one of the joists.

In some aspects, the techniques described herein relate to a photovoltaic shade structure, wherein the clamp is secured to the joist using one or more threaded fasteners.

In some aspects, the techniques described herein relate to a photovoltaic shade structure, including: a plurality of posts; a plurality of beams at least partially structurally supported by the posts; a plurality of joists at least partially structurally supported by the beams; a plurality of solar panels at least partially structurally supported by the joists; and a clamp configured for selectively securing one of the solar panels to one of the joists; wherein the solar panels are supported by the posts and beams only indirectly through the joists; and wherein each of the joists includes a longest length that is substantially perpendicular with a longest length of each of the solar panels.

In some aspects, the techniques described herein relate to a photovoltaic shade structure, wherein the clamp is attached to one of the joists.

In some aspects, the techniques described herein relate to a method of forming a photovoltaic shade structure, including: providing a plurality of posts; at least partially structurally supporting a plurality of beams with the posts; at least partially structurally supporting a plurality of joists with the beams; at least partially structurally supporting a plurality of solar panels with the joists; placing each of the solar panels in a position such that a longest length of the solar panel is substantially perpendicular to a longest length of one of the joists; and securing the solar panels in the position.

In some aspects, the techniques described herein relate to a method, further including securing one of the solar panels to one of the joists using a clamp.

General details of the above-described implementations, and other implementations, are given below in the DESCRIPTION, the DRAWINGS, the CLAIMS and the ABSTRACT.

### BRIEF DESCRIPTION OF THE DRAWINGS

Implementations will be discussed hereafter using reference to the included drawings, briefly described below, wherein like designations refer to like elements. The drawings are not necessarily drawn to scale.

FIG. 1 is a front perspective view of a prior art photovoltaic shade structure;

FIG. 2 is a front perspective view of an implementation of elements of a photovoltaic shade structure;

FIG. 3A is another front perspective view of the elements of FIG. 2;

FIG. 3B is a close-up bottom perspective view of some of the elements of FIG. 2;

FIG. 4 is a front view of an implementation of a clamp of a photovoltaic shade structure;

FIG. 5 is a front view of another implementation of a clamp of a photovoltaic shade structure;

FIG. 6 is a close-up bottom perspective view of an assembly step of the elements of FIG. 2;

FIG. 7 is a close-up bottom perspective view of another assembly step of the elements of FIG. 2;

FIG. 8 is a close-up front perspective view of beam wrap components of a photovoltaic shade structure;

FIG. 9 is a top partial cross-section view of beam wrap elements of a photovoltaic shade structure;

FIG. 10 is a front see-through view of beam wrap elements of a photovoltaic shade structure;

FIG. 11 is a close-up partial cross-section view of portions of solar panels and a bracket of a photovoltaic shade structure;

FIG. 12 is a close-up partial cross-section view of portions of solar panels, a clamp, and other elements of a photovoltaic shade structure;

FIG. 13 is a close-up partial cross-section, partial see-through view of portions of solar panels, a gutter, and other elements of a photovoltaic shade structure; and

FIG. 14 is a top view of a photovoltaic shade structure.

### DESCRIPTION

Implementations/embodiments disclosed herein (including those not expressly discussed in detail) are not limited to the particular components or procedures described herein. Additional or alternative components, assembly procedures, and/or methods of use consistent with the intended photovoltaic shade structures and related methods and assemblies may be utilized in any implementation. This may include any materials, components, sub-components, methods, sub-methods, steps, and so forth.

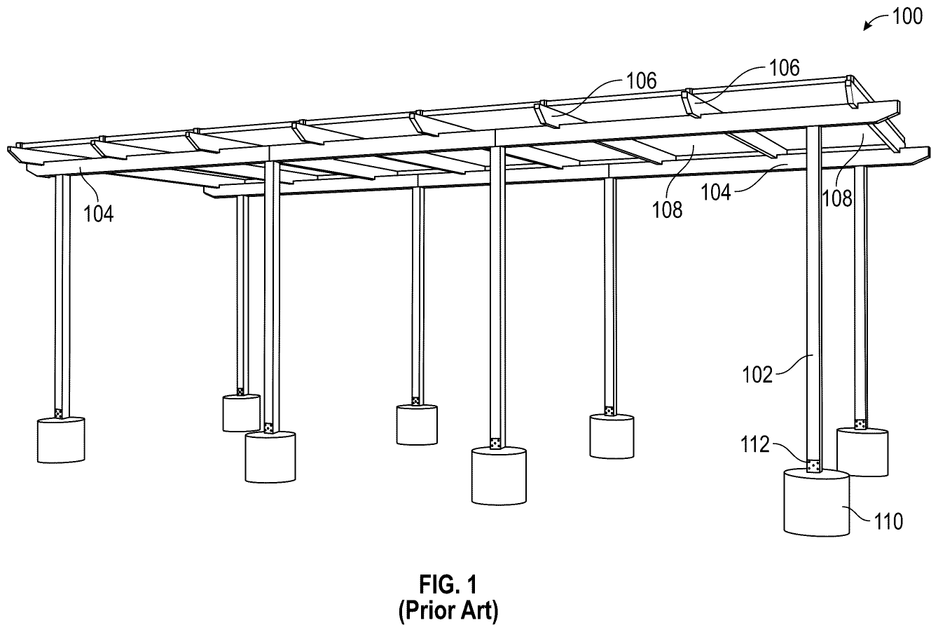

Referring to FIG. 1, an example of a prior art photovoltaic shade structure 100 is shown (shade structure 100 in the shown example is a pergola). Prior art photovoltaic shade structure 100 includes a plurality of posts 102, beams 104 coupled to the posts, a plurality of joists 106 supported by the beams, and a plurality of solar panels 108 supported by the joists. Footings 110 are coupled at the bottom of the posts (such as using couplers 112, or in implementations couplers 112 partially assist in this coupling). The footings support the posts and may in implementations be atop a ground or other surface or in some cases partially or fully buried below a ground surface for aesthetic and structural purposes. The prior art photovoltaic shade structure 100 provides shade but also, due to the plurality of solar panels 108, provides an energy capture function.

In the prior art photovoltaic shade structure 100 (and for prior art photovoltaic structures in general) the solar panels need to perfectly align so that neighboring panels both rest atop a joist 106 and can be secured thereto. Because the joists 106 are oriented so that their longest lengths are parallel with the longest lengths of the individual solar panels, and because they are relatively narrow in the transverse direction, there is very little room for error. If the joists are offset from the longest edges of neighboring solar panels by a small margin, those edges are not useful for securing the solar panels down to the rest of the structure. In practice this means that the entire shade structure must be custom built with the exact solar panel size in mind (as solar panels come in differing sizes) so that the joists will be positioned exactly under the neighboring longest edges of the chosen solar panels so that the joists may then be used in supporting and securing the solar panels. In other words, with prior art photovoltaic shade structures it is crucial that each longest edge of the solar panels aligns precisely above a respective joist. This leaves very little room for error-only a small margin of error of a few inches for the entire structure. Consequently, the structures must be meticulously constructed with the precise dimensions of the solar panels in mind. Even a slight deviation in solar panel size, or small lean in some of the posts, or slight deviation in joist location, can make it impossible to safely fasten the solar panels to the structure. Additionally, even small foundation settling over the years can lead to the solar panels no longer being safely secured to the structure.

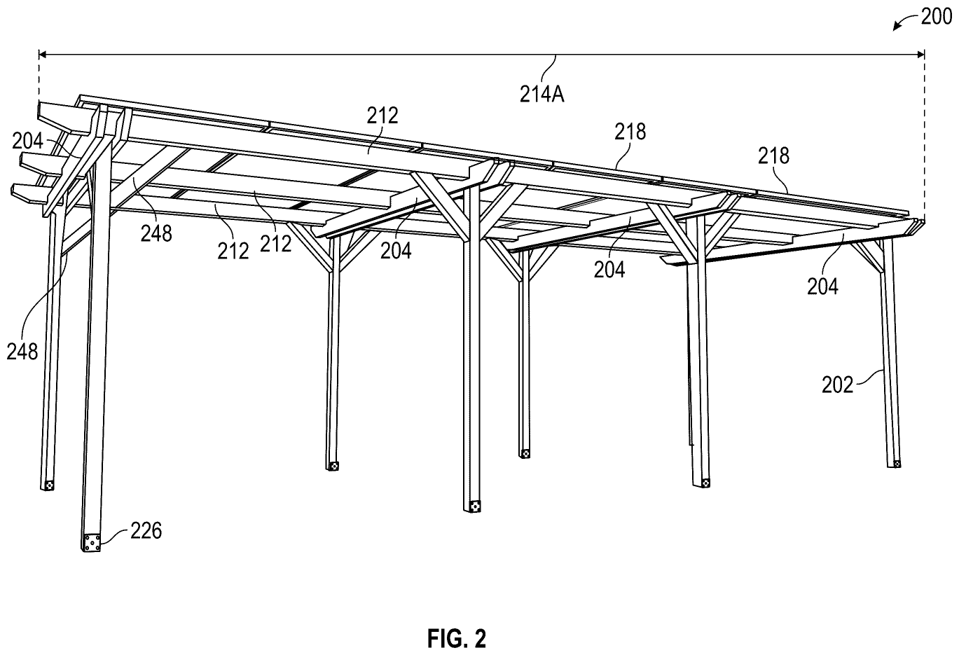

Referring now to FIGS. 2-11, in implementations a photovoltaic shade structure 200 (hereinafter PV shade structure 200 or simply shade structure 200) includes a combination of one or more of the following items: posts 202, beams 204, joists 212, solar panels 218, gaps 224 (between solar panels), standoffs 226, clamps 230 or clamps 240, threaded couplers 244, brackets 246, support members 248, and/or beam wraps 254. In some cases PV shade structure 200 includes only some of these elements, and in some cases it may include most of these elements.

The posts 202 are configured to provide support for the beams 204, which in turn provide support for the joists 212, which in turn provide support for the solar panels 218.

Each of the beams 204 includes two members 206 having an intentionally engineered gap 206B therebetween. The gap will in implementations be useful for routing electrical wiring from the solar panels to an electrical load or to power storage (for example securing wiring within the gap using staples, zip ties, tape, tubing secured therein, or using any other securing mechanism). Each beam has a longest length 206A that is seen in the drawings to be parallel with the longest lengths of the solar panels. Threaded couplers 208 and retainers 210 (which may be nuts) may be used to couple the members 206 to one another and/or to other components of the shade structure. The threaded couplers could for example be bolts, screws, or the like.

Each joist 212 includes two members 214. The members as shown in the figures don't have gaps therebetween, but in alternative embodiments they could have such gaps, such as for the same wire routing function described above. Each joist has a longest length 214A that is perpendicular with the longest length of each solar panel (for reference, edge 221A may be said to form a longest length of each solar panel, running in a direction into and out of the page in FIG. 11). This means that each solar panel may be supported by the joists regardless of where along the lengths of the joists it is placed. This is the case regardless of the size of the solar panels, so that solar panels of nearly all sizes can easily be secured to the joists. The shade structure 200 accordingly does not need to be custom built for any specific solar panel size, but can be used for a variety of solar panel sizes or any solar panel size. It is also pointed out that, due to the inverted nature of photovoltaic shade structure 200 (e.g., the longest lengths of the joists being perpendicular to the longest lengths of the solar panels, as opposed to being parallel as in the prior art photovoltaic shade structures), the dimensions of photovoltaic shade structure 200 do not have to be absolutely precise. Some variations in alignment and height, some settling over time, and some imprecise positioning of elements is allowable, and unlikely to compromise the secure nature of the solar panels or the safety of the solar panels and the overall structure.

Each joist includes a recess 216 configured to receive a corresponding beam. In implementations the recess is simply a rectangular section cut out or removed from the joist. The members of the joist may be joined together and/or to other components of the structure in the same manner as described above for the members of each beam.

Each solar panel 218 is configured to function as a conventional solar panel and includes a plurality of layers 220 as is common. The layers could include, by non-limiting examples, a transparent or translucent glass layer, an encapsulant layer such as ethylene vinyl acetate (EVA), a photovoltaic layer with solar cells, another EVA encapsulant layer, a back sheet, and so forth. Each solar panel also includes a frame 221 bordering around edges of the layers. The frame includes a lip 222 and a gap 223 exists between the lip and the bottommost layer 220. Each solar panel also includes wiring, though this is not shown in the drawings for ease of viewing other elements. The wiring is used to electrically couple the solar panels with one another and/or with an electrical load and/or an energy storage device (either directly or through additional electrical wiring). In implementations the frame comprises four aluminum C-channel sections each of which is secured against (or proximate to) one of the four sides of the stacked layers 220, the C-channel sections also joined to one another such as through screws, bolts, adhesives, or other coupling mechanisms. The C-channel sections may be secured to the stacked solar panel layers using one or more adhesives, clamps, bolts or screws passing through through-holes, and so forth. Such coupling can be done in a way so that the panels are secured at a top of the frame such that the gap 223 is formed.

In implementations the solar panels may be arranged atop the joists so that a gap 224 is formed between neighboring solar panels (the gap defined as the distance between the proximate edges 221A of the two solar panels). The gap may be useful for some techniques of securing the solar panels to the rest of the structure, as will be discussed below.

Each standoff 226 may in implementations be used to secure a post 202 to a ground or other surface. Each standoff 226 may include through holes and one or more couplers 228, which may be threaded couplers such as screws or bolts, to secure the standoff to the corresponding post. The standoffs in the drawings are conventional, off-the-shelf prior art standoffs.

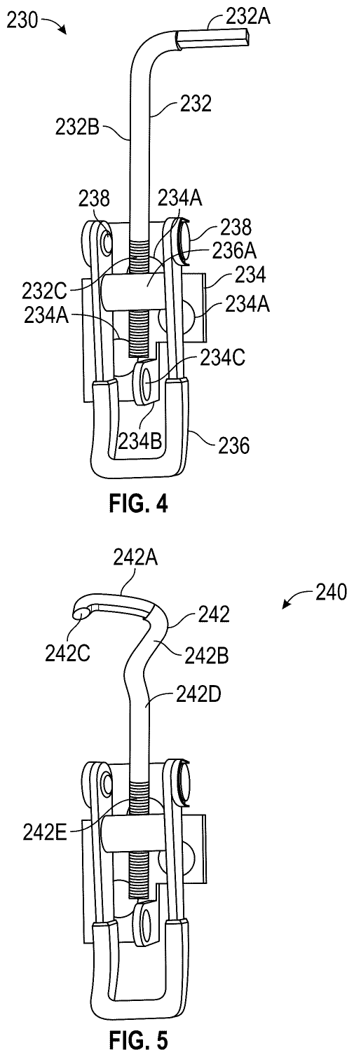

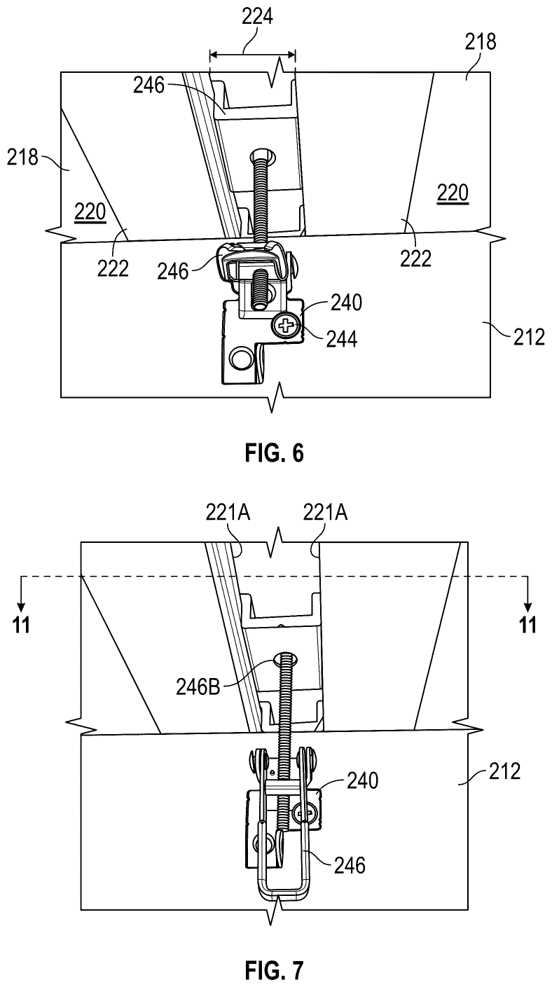

FIG. 4 shows a clamp 230 that is configured to secure a solar panel to a joist. Clamp 230 could be secured to a joist 212 similar to how clamp 240 is coupled to joist 212 in FIG. 6, using a threaded coupler 244 such as a screw or bolt, except that the clamp 230 would be shifted to the right or left so that it is below one of the lips 222. This allows the horizontal section 232A of the threaded bar to be positioned so as to be within the gap 223 to allow the clamp to put downward pressure on the lip to secure the solar panel down. The vertical section 232B of the threaded bar 232 includes threads 232C that mate with threads (not shown) of cross member 236A. The cross member is secured to a lever arm 236 which pivots relative to a base 234. Couplers 238 secure the lever arm to the base, and may for example include any coupler or coupling mechanism which allows rotational movement of the lever arm relative to the base. The base includes through-holes 234A, one or more of which may be used to secure the clamp to a joist 212 such as with threaded couplers 244. A locking tab 234B extends from the base and includes a through-hole 234C which may receive, for example, a padlock or other locking element, so as to prevent the lever arm from being lifted to release a solar panel.

Clamp 230 operates in a simple fashion. Either before or after securing base 234 to the joist 212, the threaded bar 232 may be rotated to adjust its height relative to the base and lever arm. Cross member 236A may rotate relative to lever arm 236, by being coupled thereto using any coupling which allows such rotation. Once the desired height is achieved for the threaded bar, such that it would provide sufficient downward pressure on the lip when clamped, the lever arm is then lowered and, if desired, locked in place with a padlock or any other element passed through the through-hole 234C. The locking step may be excluded in some cases. In some cases, when adjusting for the proper height of the threaded bar 232 and then raising the horizontal section above and past the lip, the user may orient the horizontal section 232A away from the lip for clearance until the horizontal section is above the lip, and then may orient the horizontal section 232A in the opposite direction so that it is then in the gap between the lip and the solar panel layers when the lever arm is lowered to secure the solar panel down. Naturally, the horizontal sections can be oriented left or right, so for example referring to FIG. 11 a right-facing horizontal section 232A of a clamp 230 could secure the lip of the solar panel shown on the left, and a left-facing horizontal section 232A of a clamp 230 could secure the lip of the solar panel shown on the right.

In contrast to clamps 240, clamps 230 may secure the solar panels without requiring a gap between them (indeed the use of clamp 230 allows the edges 221A of neighboring solar panels to contact one another without any gap therebetween). This can help to make the shade structure waterproof and/or to ensure shade without gaps which would let sunlight through.

The clamp 240 is identical to clamp 230 except having a threaded bar 242 which is different. Threaded bar 242 includes a horizontal section 242A, angled section 242B, protrusion 242C, and a vertical section 242D having threads 242E.

Clamp 240 is used together with conventional prior art off-the-shelf bracket 246. The bracket is configured to sit within the gap 224 and to provide downward pressure on the frames 221 of neighboring solar panels to secure them down. Referring to FIGS. 5, 7, and 11, each bracket includes a first portion 246A having a through hole 246B for the threaded bar 242 to pass through, two vertical extensions 246C, and two lips 246D each having ridges 246E for improving friction/grip relative to the frame 221. The horizontal section 242A may in implementations rest atop the upper surface of first portion 246A, and in implementations protrusion 242C extends beyond an edge of first portion 246A. In other implementations protrusion 242C may itself contact the upper surface of first portion 246A to provide downward pressure thereon. In implementations each gap includes only two brackets therein, one proximate a first distal end of the longest lengths of the solar panels and another proximate the opposite distal end of the longest lengths, the two separate brackets corresponding with the two separate joists, respectively. In other implementations each gap includes two brackets on opposite sides of each joist (as in FIGS. 6-7) for a total of four brackets along each gap. As seen in the drawings, in some implementations in which clamps 240 are used to secure solar panels down, the gaps 224 remain between neighboring solar panels. Even so, in some implementations clamps 240 could be used with solar panels that have no gap 223 by having the clamps only on the outer-facing sides of the joists and having each threaded bar 242 pass upward past the shortest length of a solar panel (instead of between solar panels through the gap) and clamping down directly on the top of the frame (such implementations may require reshaping of each threaded bar 242 so that it has clearance to pass upward and past the shortest length of its corresponding solar panel).

It is pointed out that FIG. 11 is only a partial cross-section view, as the bracket is not sectioned (as can be seen by the cross-section line indicated in FIG. 7). In some implementations the bracket could extend the full length of the gap 224 along the longest length of the solar panel(s) to provide waterproofing and to prevent sunlight passing therethrough. In such cases it could have two through-holes, one for each end to secure to the corresponding joist through a corresponding clamp 240.

Support members 248 are configured to provide additional structural support. Each support member 248 includes a beam 250 and couplers 252, such as threaded couplers like bolts or screws, securing the beam to one of the posts and also to either a beam or joist. The support members are shown as being oriented at 45-degree angles but in implementations could be oriented at different angles.

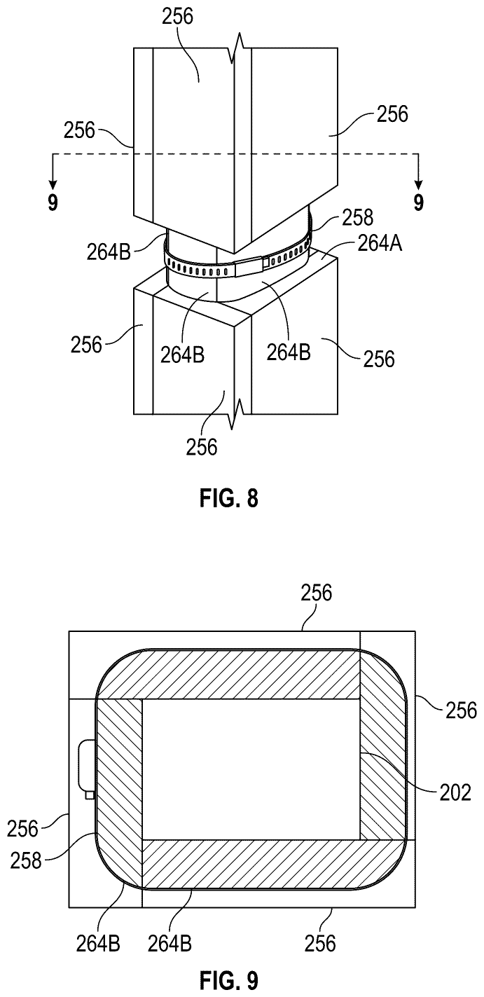

FIGS. 8-10 show an example beam wrap 254 which may be coupled with a post 202 for decorative purposes. The posts (as with the beams, joists, support members, and other members of the photovoltaic shade structure) may be formed of wood, such as 2×4s, 4×4s, 2×6s, and so forth. The beam wrap may be made of wood or of other elements such as plastic, metals, or composite materials having one or more of these elements joined together through adhesives or nails/screws or other coupling mechanisms. The beam wrap elements may include design elements thereon such as colors, stylistic designs, and so forth according to the desires of the user, for aesthetic purposes.

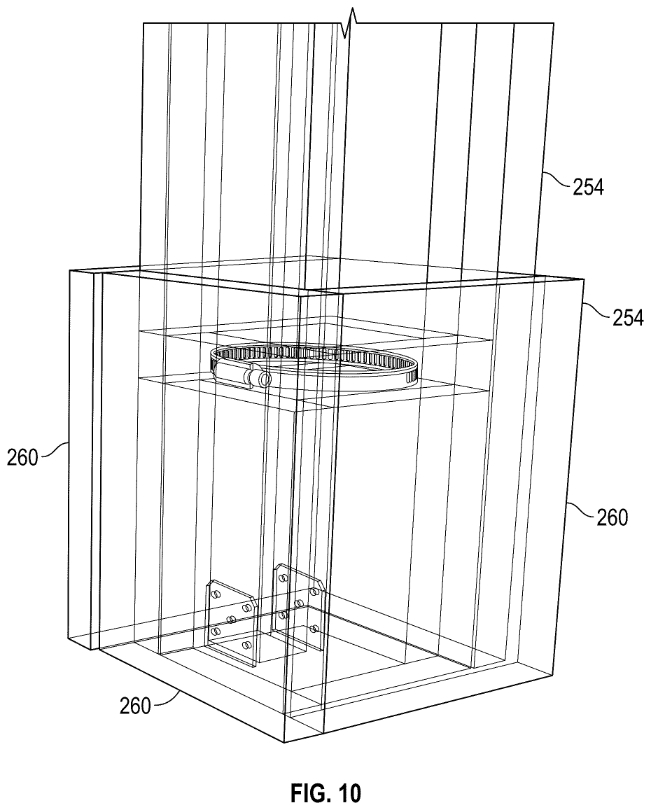

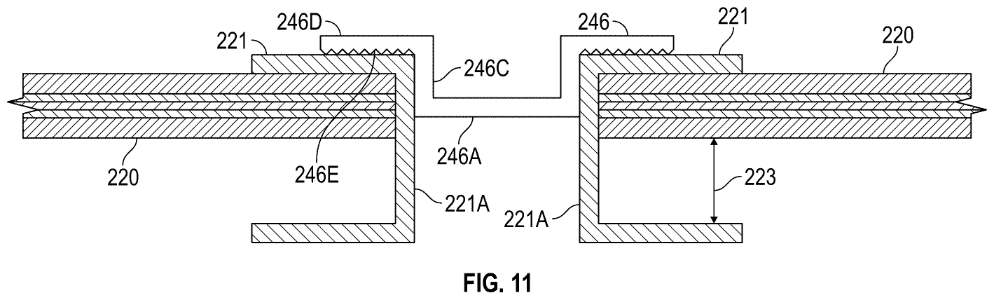

Each beam wrap includes a plurality of inner panels 256. Each inner panel may have a routed section 264B which forms a recess 264A, as seen in FIG. 8 and in the top cross-section view of FIG. 9 where each routed section of each inner panel is shown in cross-section format (while the rest of each inner panel is not in cross-section format). A clamp 258 (such as a worm-drive clamp) couples around the routed sections and may be tightened to secure the inner panels against the post. As seen in the see-through view of FIG. 10, outer panels 260, which may be formed of the same material as the inner panels, and which may also have colors and design elements, may be coupled over the inner panels to obscure or hide the clamp and routed sections. The outer panels could be secured to the inner panels and/or to one another using an adhesive, screws, nails, a friction fit, vertical sliding interlocking elements, lock miters, and so forth. In implementations the outer panels function as a trim to cover the routed sections and clamp 258.

The routed sections could be formed by machining or could be integrally formed in the inner panels during manufacturing, such as using a mold having the routed sections formed therein.

FIGS. 8-10 show an example of a beam wrap which is secured around a bottom portion of a post, but a beam wrap could alternatively or additionally be wrapped around a top portion of a post. In some cases each beam wrap is secured around the corresponding post in two locations, proximate the post's bottom and proximate the post's top. In such implementations each inner panel may extend all the way from a joist to a ground or other surface at a bottom of the corresponding post, with each lower outer panel abutting the ground or other surface or being proximate thereto and each upper outer panel abutting the corresponding joist or being proximate thereto. In implementations the beam wraps may make the post portions appear larger than they are, for aesthetic purposes.

In implementations the beam wrap is configured to be installable by the end consumer. The beam wrap elements may in implementations be formed of wood, with each routed section being a section of the wood that is routed from a rectangular profile to a semi-circular, or otherwise rounded, profile.

While there are other possible methods for securing the beam wraps to the posts, using worm clamps and lock miters or other easily removable securing mechanisms allows the end user to have differently-styled beam wraps for different occasions and/or seasons and to interchange them easily.

The photovoltaic shade structure 200 disclosed herein allows solar panels to be mounted directly onto the joists without the use of racking.

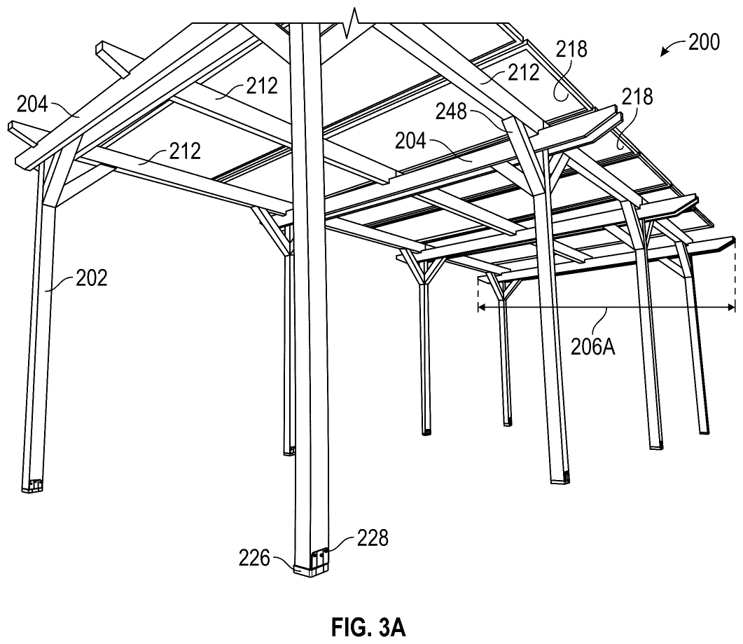

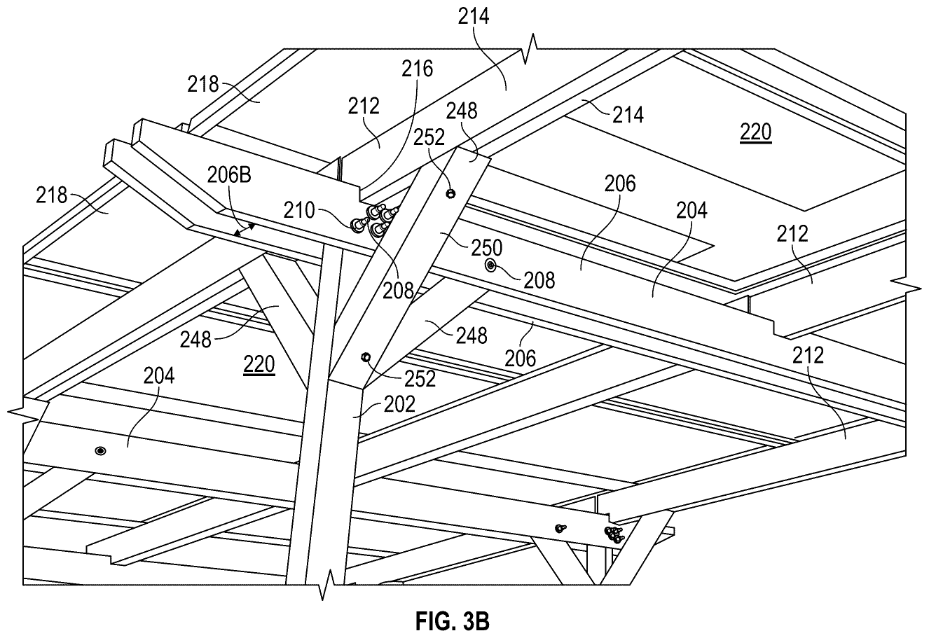

In implementations the posts contact the joists directly and thus support them at the recesses 216. For example, in FIGS. 3A and 3B each post extends between a gap 206B, and may extend all the way to the corresponding joist. In other implementations there may be a gap between the joists and the posts so that the posts structurally support the joists only indirectly through the beams and/or support members.

Referring to FIG. 2, it is pointed out that a center section of the photovoltaic shade structure 200 may be replicated to accomplish any desired length. The replicable section may include two posts, a beam or portion thereof, members to extend the joists, and corresponding support members. A photovoltaic shade structure 200 could be separated at the center and another replicable section put in, in order to extend its length further. Alternatively, the photovoltaic shade structure 200 could be shortened by removing one or more replicable center sections. For example, the photovoltaic shade structure 200 of FIG. 2 could have some of the above center elements removed so that it only has four posts, instead of eight, and two beams instead of four, with corresponding support member and joist segments removed as appropriate to shorten the structure.

The posts need not be perfectly vertical and, in implementations, are only substantially vertical, meaning within 30 degrees of perfect verticality.

The photovoltaic shade structure 200 may further include any elements, details, dimensions, characteristics, materials, additional components, or the like disclosed in any of the Appendices A-D of the above-referenced U.S. Provisional Patent App. No. 63/587,109 which are incorporated herein by reference. It is pointed out that the hand-drawn highlighting in Appendix B of the '109 application shows approximate locations of wiring for the solar panels, and it can be seen that some of the wiring is routed within the gaps of the joists, as disclosed above. The gap accordingly facilitates wiring/cable management. In implementations one or more inserts are included within the gaps to hide all the wires and provide a support for the wires to rest on. The dimensions given in the appendices of the '109 application are only example dimensions, and in other implementations any other feasible dimensions may be used. Appendix D of the '109 application includes example dimensions and details of a bracket 246.

In some cases the clamps 230/240 and/or brackets 246 may be used for grounding the solar panels, though in other implementations this is instead or additionally done through wiring elements of the solar panels or in another manner. The use of clamps 230/240 allows the solar panels to be secured from below the shade structure or pergola. This removes the need for someone to essentially walk on the panels or on top of the joists to secure the solar panels down.

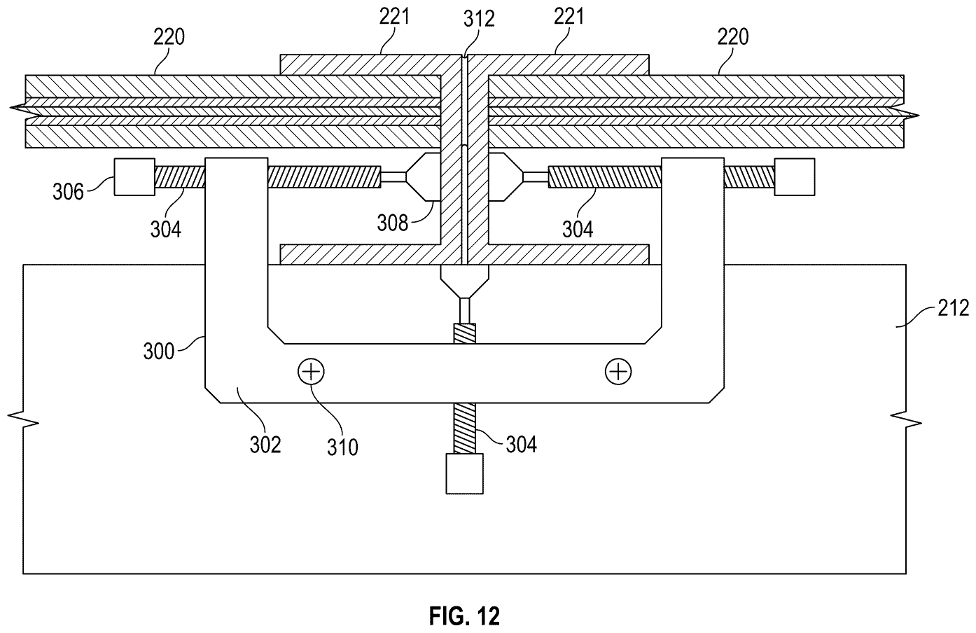

FIGS. 12-14 show alternative or additional components/features for PV shade structures. These details may be combined with any of the other PV shade structure elements disclosed herein.

FIG. 12 shows a clamp 300 which includes a body 302 (which could be formed of a metal, rigid polymer or composite, or other rigid member) and which includes a plurality of screw holes or openings (not visible) through which threaded fasteners 310 (which may be screws, bolts, etc.) secure the clamp 300 to a joist 212. The body 302 also has three threaded openings (not shown) each having a threaded member 304 coupled therein. Two of the threaded members are seen to press or bias the two adjacent solar panels toward one another (thus forming a better seal), and the other is seen to abut (and push up against) a bottom of the frames of each solar panel. Each threaded member 304 has a head 306 used to rotate the threaded member 304 and an end 308 which abuts the frame(s) 221, thus securing the frame 221 to the joist 212 via the clamp 300. The head could comprise a bolt head having a Phillips, flathead, hex, or torque configuration, or any other configuration, for facilitating its rotation. The plurality of layers 220 of each solar panel 218 are also seen in FIG. 12. A sealant 312 is shown deposited between the frames 221, thus providing a water-tight seal to prevent water from falling therethrough to below the PV shade structure. Various sealant types are possible, but as a non-limiting example the sealant could be formed of a silicone caulk or the like. The clamp configuration shown in FIG. 12 may be an alternative to the clamp configuration(s) shown in other drawings. In FIG. 12 the solar panels and sealant are shown in cross-section (similar or the same as the cross-section location of FIG. 11, referenced in FIG. 7), while the remaining elements are not shown in cross-section.

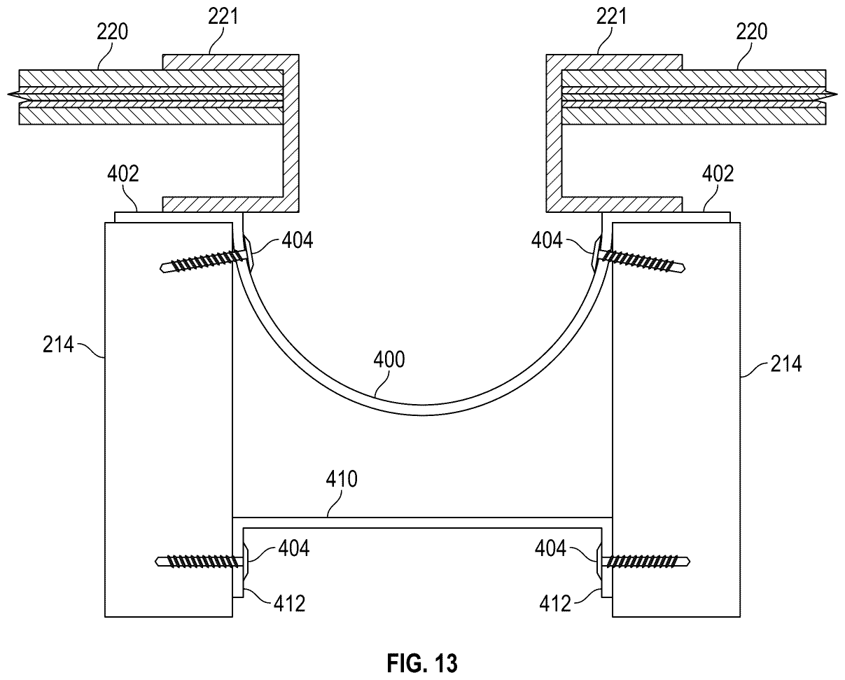

FIG. 13 shows a view transverse to that shown in FIG. 12. The two members 214 of the joist 212 are seen to have a space therebetween (as opposed to the configuration of FIG. 3B for instance, where they abut one another). This spacing allows a gutter 400 to be secured between the two members 214 using threaded fasteners 404 which pass through holes in the gutter 400. The gutter has two lips 402 each of which rests atop one of the two members 214 so that it is sandwiched between a member 214 and one of the frames 221. In FIG. 13 the solar panels are shown in cross-section while the gutter 400, cable rest 410 and two members 214 are shown in partial see-through view so that the placement of the threaded fasteners 404 can be seen.

A cable rest 410 is also secured between the two members 214. The cable rest 410 includes two side members 412 each of which is secured to one of the two members 214 using a threaded fastener 404 which passes though a hole in the side member. The cable rest may be used to rest/route cables, power cords, and the like thereon so and/or may be used so that the cables/cords are not visible below the PV shade structure. Holes/openings/grooves may be created in some structural or other components of the PV shade structure (such as any of the joists or beams or the like), in some cases, to facilitate connecting the cables/cords to individual solar panels, and/or the cables/cords could connect to the solar panels at the outer edges of the PV shade structure. The plurality of layers 220 of each solar panel are also seen in FIG. 13.

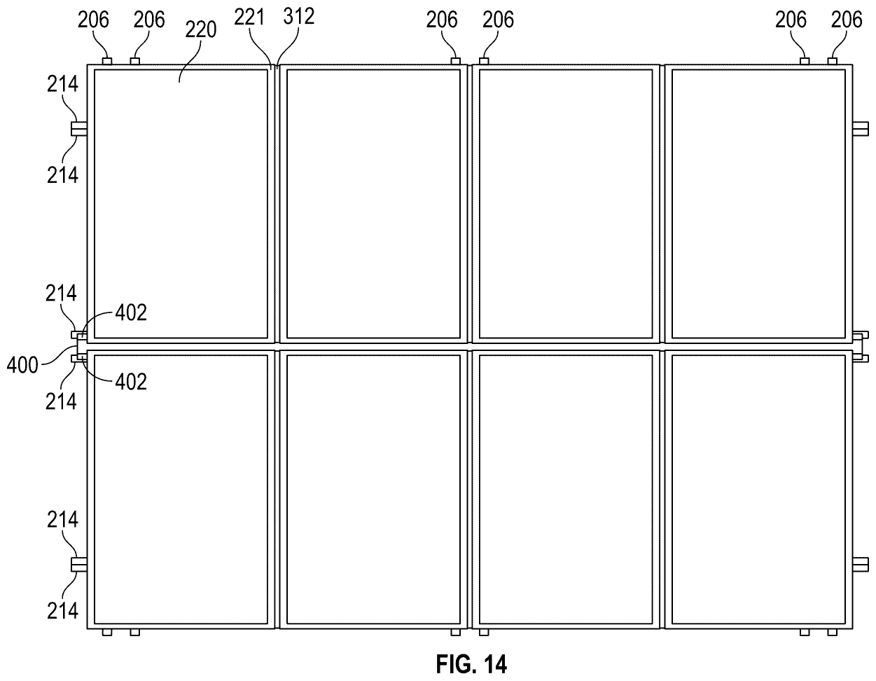

The gutter 400 is useful to collect rainwater and/or snow/snowmelt from atop the solar panels and to route it to an end of the shade structure so that the area below the shade structure remains dry. FIG. 14 shows a top view of a PV shade structure wherein there are eight solar panels, each having a plurality of layers at least partially secured within a frame 221. A sealant 312 is seen to be deposited between long ends of each pair of adjacent solar panels. The gutter 400 and its two lips 402 are visible, resting atop two members 214 that are spaced apart to make room for the gutter. Other members 214 are seen supporting the solar panels. Several members 206 are also seen, they in turn supporting the members 214. The top view of FIG. 14 thus shows that rainwater and snow/snowmelt cannot slip between adjacent long edges of the solar panels, due to the sealant in those locations, and between adjacent/proximate short edges it falls down into the gutter so that it is routed to one or more ends/edges of the shade structure, thus keeping the footprint below the shade structure dry. Additional gutter extension elements may also be added to route the water down to the ground or to any other desired location.

The configurations shown in FIGS. 12-14 are only representative examples, and other configurations are possible for sealants, clamps, and so forth. More than one gutter could be used in some examples, and in some cases the gutter(s) could be placed in a direction transverse to that shown in FIG. 14 though this may require some modifications to the shade structure examples shown in the drawings.

It can be seen in FIG. 14 that, in implementations, the gutter is centrally located between two rows of the solar panels and extends from a first outer edge of the photovoltaic shade structure (on the left in the image) to a second outer edge of the photovoltaic shade structure (on the right in the image). Although FIG. 13 shows a gutter and cable rest within the same gap, in some cases with three joists a center gap (in a center joist 212) will house the gutter and the two side joists will have gaps that house cable rests. In some cases the cable rests may have holes or perforated portions (for example the main portion apart from the side members may be perforated) to allow cables to pass through the perforations as needed. In some cases the solar panels may be slightly angled to bias water to run toward the gutter.

Unless otherwise indicated, the term “substantially” as used herein may mean within 80% of the given length, angle, size, or other metric.

The various devices and/or assemblies disclosed herein and their elements, sub-elements, sub-assemblies, and so forth may be formed from any materials that will feasibly allow, facilitate, and/or otherwise not hinder their respective functions as described herein. For example, any of the devices, elements, or sub-elements may, wherever possible, be formed of metals, polymers, composites, ceramic materials, fabrics, and so forth.

Furthermore, there are a variety of ways in which the various elements may be directly or indirectly coupled together. Notwithstanding the specific ways in which elements are depicted as being coupled together herein, these same elements could, wherever feasible, be joined together in any of the following ways: manually removably coupled together such as using hook and loop fasteners, a reusable adhesive, manually removable bolts and nuts or screws or other threaded fasteners, and any other type of manually removable coupling mechanism; or fixedly/permanently coupled together such as using a permanent adhesive, rivets, welding, melt joining or heat bonding, and any other type of permanent coupling mechanism that is not manually removable. Manually removable, as defined herein, refers to the ability to remove a coupling using manual force either using hands alone or using non-powered hand tools.

In places where the phrase “one of A and B” is used herein, including in the claims, wherein A and B are elements, the phrase shall have the meaning “A and/or B.” This shall be extrapolated to as many elements as are recited in this manner, for example the phrase “one of A, B, and C” shall mean “A, B, and/or C,” and so forth. To further clarify, the phrase “one of A, B, and C” would include implementations having: A only; B only; C only; A and B but not C; A and C but not B; B and C but not A; and A and B and C.

In places where the description above refers to specific implementations of photovoltaic shade structures and related methods and assemblies, one or more or many modifications may be made without departing from the spirit and scope thereof. Details of any specific implementation/embodiment described herein may, wherever possible, be applied to any other specific implementation/embodiment described herein. The appended claims are to encompass within their scope all such changes and modifications as are within the true spirit and scope of this disclosure.

Furthermore, in the claims, if a specific number of an element is intended, such will be explicitly recited, and in the absence of such explicit recitation no such limitation exists. For example, the claims may include phrases such as “at least one” and “one or more” to introduce claim elements. The use of such phrases should not be construed to imply that the introduction of any other claim element by the indefinite article “a” or “an” limits that claim to only one such element, and the same holds true for the use in the claims of definite articles.

Additionally, in places where a claim below uses the term “first” as applied to an element, this does not imply that the claim requires a second (or more) of that element-if the claim does not explicitly recite a “second” of that element, the claim does not require a “second” of that element. Furthermore, in some cases a claim may recite a “second” or “third” or “fourth” (or so on) of an element, and this does not necessarily imply that the claim requires a first (or so on) of that element-if the claim does not explicitly recite a “first” (or so on) of that element (or an element with the same name, such as “a widget” and “a second widget”), then the claim does not require a “first” (or so on) of that element.

Method steps disclosed anywhere herein, including in the claims, may be performed in any feasible/possible order. Recitation of method steps in any given order in the claims or elsewhere does not imply that the steps must be performed in that order-such claims and descriptions are intended to cover the steps performed in any order except any orders which are technically impossible or not feasible. However, in some implementations method steps may be performed in the order(s) in which the steps are presented herein, including any order(s) presented in the claims.

What is claimed is:

1. A photovoltaic shade structure, comprising:
a plurality of posts;
a plurality of beams at least partially structurally supported by the posts;
a plurality of joists at least partially structurally supported by the beams; and
a plurality of solar panels at least partially structurally supported by the joists;
wherein each of the joists comprises a longest length that is substantially perpendicular with a longest length of each of the solar panels.

2. The photovoltaic shade structure of claim 1, wherein each of the joists is formed of multiple members.

3. The photovoltaic shade structure of claim 2, further comprising a gutter secured between two of the multiple members of one of the joists, the gutter configured to route rainwater to an outer edge of the photovoltaic shade structure.

4. The photovoltaic shade structure of claim 3, wherein the gutter is centrally located between two rows of the solar panels, and wherein the gutter extends from a first outer edge of the photovoltaic shade structure to a second outer edge of the photovoltaic shade structure.

5. The photovoltaic shade structure of claim 2, further comprising a cable rest secured between two of the multiple members of one of the joists, the cable rest configured for routing electrical wiring from the solar panels to an electrical load or to power storage.

6. The photovoltaic shade structure of claim 5, further comprising a gutter configured to route rainwater to an outer edge of the photovoltaic shade structure.

7. The photovoltaic shade structure of claim 1, wherein each of the beams is formed of multiple members.

8. The photovoltaic shade structure of claim 7, wherein at least one of the beams comprises a gap formed between two of its multiple members, the gap configured for routing electrical wiring from the solar panels to an electrical load or to power storage.

9. The photovoltaic shade structure of claim 1, further comprising a clamp configured for selectively securing one of the solar panels to one of the joists.

10. The photovoltaic shade structure of claim 9, further comprising a bracket configured to couple the clamp with the solar panel, the bracket configured to provide a downward force on the solar panel in response to a movement of the clamp.

11. The photovoltaic shade structure of claim 9, wherein the clamp is configured to secure two adjacent solar panels to the joist.

12. The photovoltaic shade structure of claim 9, wherein the clamp comprises a locking mechanism which, when in a locked configuration, prevents the secured solar panel from being decoupled from the joist.

13. The photovoltaic shade structure of claim 1, further comprising a beam wrap substantially covering one of the posts.

14. The photovoltaic shade structure of claim 1, further comprising a sealant joining adjacent surfaces of two of the solar panels, the sealant preventing water from passing therethrough.

15. The photovoltaic shade structure of claim 1, further comprising a clamp configured to push two of the solar panels toward one another and to secure the two solar panels to one of the joists.

16. The photovoltaic shade structure of claim 15, wherein the clamp is secured to the joist using one or more threaded fasteners.

17. A photovoltaic shade structure, comprising:
a plurality of posts;
a plurality of beams at least partially structurally supported by the posts;
a plurality of joists at least partially structurally supported by the beams;
a plurality of solar panels at least partially structurally supported by the joists; and
a clamp configured for selectively securing one of the solar panels to one of the joists;
wherein the solar panels are supported by the posts and beams only indirectly through the joists; and
wherein each of the joists comprises a longest length that is substantially perpendicular with a longest length of each of the solar panels.

18. The photovoltaic shade structure of claim 17, wherein the clamp is attached to one of the joists.

19. A method of forming a photovoltaic shade structure, comprising:
providing a plurality of posts;
at least partially structurally supporting a plurality of beams with the posts;
at least partially structurally supporting a plurality of joists with the beams;
at least partially structurally supporting a plurality of solar panels with the joists;
placing each of the solar panels in a position such that a longest length of the solar panel is substantially perpendicular to a longest length of one of the joists; and
securing the solar panels in the position.

20. The method of claim 19, further comprising securing one of the solar panels to one of the joists using a clamp.
